(19) United States
(12) Patent Application Publication
(10) Pub. No.: US 2003/0140256 A1
(43) Pub. Date: Jul. 24, 2003

(54) Wireless local communication network, access control method for a wireless local communication network and devices suitable therefor

(75) Inventors: Felix Hauenstein, Oberdiessbach (CH); Eric Lauper, Bern (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: SWISSCOM MOBILE AG, Bern (CH)

(21) Appl. No.: 10/349,077

(22) Filed: Jan. 23, 2003

(30) Foreign Application Priority Data
Jan. 24, 2002 (EP) 02405043.7

(51) Int. Cl. H04L 9/00

(52) U.S. Cl. 713/201

(57) ABSTRACT

In a wireless local communication network, a so-called Wireless Local Area Network (WLAN) a prepaid value code is transmitted from a wireless communication terminal via an air interface to an access point unit of the wireless local communication network, a so-called access point. The validity of the received value code is checked in a value code database by a centralized access control server. If applicable, the access to the wireless local communication network and to communication networks connected thereto, for example the Internet, is cleared for the wireless communication terminal. After the clearance, a monetary amount is credited to the operator of the access point unit and the validated value code is cancelled in the value code database.

### TECHNICAL FIELD

This invention relates to a wireless local communication network, an access control method for a wireless local communication network and devices suitable therefor. The invention relates in particular to a wireless local communication network which comprises at least one wireless communication terminal, at least one access point unit with a transceiver for communication with the wireless communication terminal via an air interface and an access control module for checking the access authorization of the wireless communication terminal, an access control method for such a wireless local communication network and an access control server suitable therefor and a computer program product for control of this access control server.

### BACKGROUND ART

Wireless local communication networks, so-called Wireless Local Area Networks (WLAN), serve users with mobile terminals as communication systems for communication with other communication units, either as an extension for access to a fixed network, for example a local communication network (Local Area Network, LAN), the public switched telephone network (PSTN) or the Internet, or as an alternative to a (wired) fixed network for communication with other communication terminals. In a WLAN, data are transmitted in each case via an air interface. Without using a physical connection, pieces of information are transmitted from one point to another by means of electromagnetic waves, in particular radio or infrared waves. A typical WLAN comprises at least one point of access, a so-called Access Point (AP), and at least one wireless communication terminal, for example a laptop or palmtop computer, for instance a so-called Personal Data Assistant (PDA), or a mobile telephone. An AP comprises at least one transceiver and an antenna for the exchange of data with the wireless communication terminal via an air interface. A device configuration which embodies an AP is designated in this text as an access point unit. In a WLAN a plurality of access point units can be connected together via communication channels. One or more access point units of a WLAN can be connected to a fixed network, whereby the access of the WLAN to the fixed network is typically protected through access controls.

Described in the patent application EP 1 081 895 A1 is a secured WLAN in which a plurality of access point units of the WLAN are connected to an authentication server which controls the access to a fixed network. According to EP 1 081 895 A1, the wireless communication terminals each transmit, when taking up communication, an encrypted authentication message to an access point unit of the WLAN. According to EP 1 081 895 A1, an authentication message comprises validation information about the wireless communication terminal and about its user, for instance a device code, a user name and a user password. The access point unit, according to EP 1 081 895 A1, has an authentication module which checks the authenticity of the wireless communication terminal on the basis of the received device code. According to EP 1 081 895 A1, the user name and the user password which have been received from an authenticated wireless communication terminal are transmitted by the access point unit for checking to the authentication server which gives the wireless communication terminal access to the fixed network in the case of positive authentication of the user.

The system described in EP 1 081 895 A1 makes possible control of the access of a wireless communication terminal to a WLAN and to a fixed network connected thereto. The system according to EP 1 081 895 A1 has the drawback, however, that both the wireless communication terminal and its user must be registered with the access point unit of the WLAN, or respectively with the authentication server. This registration makes preservation of the anonymity of the user impossible, and moreover requires, as a rule, considerable administrative and/or technical expense.

Described in the patent application WO 01/41081 is a method and a system for control of the access to services in a wireless communication network. According to WO 01/41081, encoded tokens, which can be created in exchange for prepayment, for the access to wireless local networks are transmitted wirelessly to an access control device, where they are validated by means of a database. According to WO 01/41081, certain conditions, such as access time window, are defined corresponding to the content of a validated token.

### DISCLOSURE OF THE INVENTION

It is an object of the present invention to propose a wireless local communication network, an access control method for a wireless local communication network and devices suitable therefor, which do not have the drawbacks of the state of the art.

These objects are achieved, according to the present invention, in particular through the elements of the independent claims. Further preferred embodiments follow moreover from the dependent claims and from the description.

The above-mentioned objects are achieved through the invention in particular in that a wireless communication terminal in the wireless local communication network comprises a request module for transmission of a prepaid value code via the air interface to an access point unit of the wireless local communication network, in that the wireless local communication network comprises a value code database, in that the access control module of the wireless local communication network comprises a validation module for validating the received value code in the value code database, in that the access control module comprises a clearance module for clearing access to the access-controlled communication network modules for the wireless communication terminal, and in that the access control module comprises a cancellation module for cancelling the validated received value code in the value code database. Such a wireless local communication network has the advantage that the access of wireless communication terminals to communication network modules can be controlled without the users or their communication terminals having to be registered and without the users having to reveal thereby their identity. The access-controlled communication network modules preferably comprise a communication module for data communication with other communication units over the wireless local communication network, for example a communication module for data communication with other communication terminals in the wireless local communication network or a communication module for data communication with communication units in a communication network connected to the wireless local communication network, e.g. the Internet. In such a wireless local communication network the access to the wireless local communication network and to communication networks connected thereto can thus be controlled and can be granted in exchange for a prepaid value code.

According to the invention, the access control module is located in an access control server, connected to the access point unit, and the access point unit comprises a communication module for transmission to the access control server of the prepaid value code and of an operator identification. The access control server preferably comprises a billing module for crediting a monetary amount to the operator of the access point unit identified through the operator identification. The access control server facilitates a centralized execution of the access control for a plurality of access point units, the access point units being assigned, if applicable, to different wireless local communication networks. Through the transmission of the operator identification to the access control server moreover the crediting of monetary amounts to the operators of access point units can be centralized and can be carried out according to the use of their respective access point units. This preferred embodiment variant thus makes possible centralization of the access control and billing for a plurality of access point units and wireless local communication networks.

In an embodiment variant, the access control module comprises a blocking module for determining blocking conditions based on the received value code and for blocking access to the access-controlled communication network modules for the wireless communication terminal upon fulfillment of the determined blocking conditions. This embodiment variant has the advantage that value codes with different denominations can be issued which entitle one to different services, for example to a differing maximal clearance duration (access time) or to different maximal data volumes transmitted over the wireless local communication network.

In an embodiment variant, the access control module comprises a blocking module for blocking access for the wireless communication terminal to the access-controlled communication network modules according to a set clearance time or according to a set data volume. This embodiment variant has the advantage that no value codes with different denominations have to be issued and administered, so that all value codes entitle one to the same services, for example to a clearance time during a set clearance duration or up to a set blocking time point or up to a set maximal data volume transmitted over the wireless local communication network.

In addition to a wireless local communication network according to the invention, the present invention relates to an access control method for a wireless local communication network, to an access control server suitable therefor and to a computer program product for control of this access control server.

### BRIEF DESCRIPTION OF THE DRAWINGS

An embodiment of the present invention will be described in the following with reference to an example. The example of the embodiment is illustrated by the following attached figures:

FIG. 1 shows a block diagram illustrating schematically wireless communication terminals which are each connected via access point units to an access control server.

FIG. 2 shows a flow chart illustrating schematically one possible sequence of steps during the access control.

### MODES FOR CARRYING OUT THE INVENTION

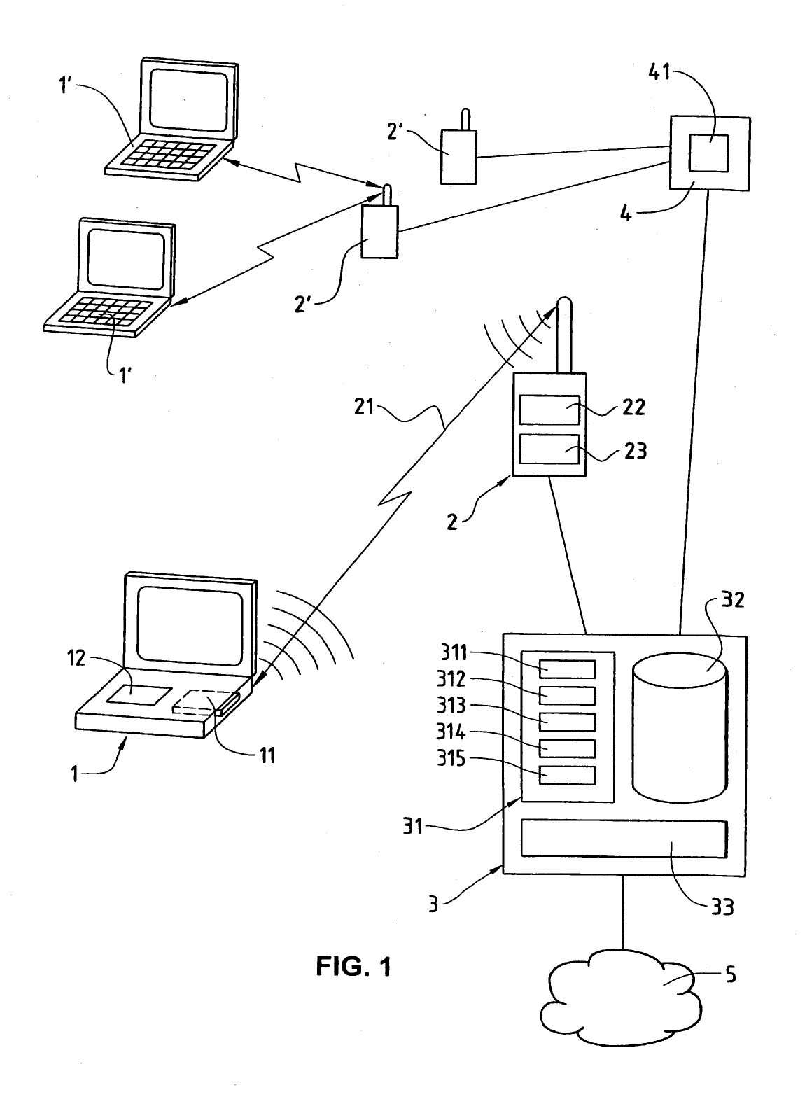

In FIG. 1 the reference numeral 1 refers to a wireless communication terminal, for instance a laptop or palmtop computer, e.g. a so-called Personal Data Assistant (PDA), or a mobile telephone. The wireless communication terminal 1 comprises a communication module 11 for data communication over a wireless local communication network, a so-called WLAN (Wireless Local Area Network). The communication module 11 is installed in a fixed way in the communication terminal 1 or in the form of a insertable card removably connected to the wireless communication terminal 1. The wireless local communication network is preferably based on radio waves, e.g. according to the IEEE 802.11 (Institute of Electrical and Electronics Engineers) norm or according to a norm for a piconet, for instance according to the device interface known by the name Bluetooth; it can also be based on infrared, however. The wireless communication terminal 1 comprises moreover a request module 12, a programmed software module which is executed on a processor of the wireless communication terminal 1. With the aid of the communication module 11, the request module 12 transmits a value code via an air interface 21 to an access point unit 2 of the wireless local communication network. In FIG. 1 the reference numeral 1′ likewise refers to a wireless communication terminal, which corresponds to the wireless communication terminal 1, but is shown in less detail.

As is shown in FIG. 1, the wireless local communication network comprises access point units 2, 2′, so-called access points. Access point units 2, 2′ can be set up, for example, at places accessible to the public such as railway stations, airports or museums, at places with controlled public access, such as hotels, conference rooms or schools, or at places with controlled private access, such as company buildings or premises. As is shown schematically for the access point unit 2 in FIG. 1, the access point units 2, 2′ each comprise a transceiver 22 for data communication with the wireless communication terminals 1 1′ via the air interface 21.

The access point unit 2 is directly connected to the access control server 3 via a communication link. As is shown schematically for the access point unit 2′, a plurality of access point units 2′ can also be connected to the access control server 3 via a network server 4. The network server 4 comprises a switching module 41, which coordinates the data communication for wireless communication terminals 1′ via a plurality of access point units 2′, so that wireless communication terminals 1′ can communicate with one another via different access point units 2′ and so that a wireless communication terminal 1′ can move between access point units 2′. Furthermore the switching module 41 makes possible data communication with the access control server 3.

As shown schematically for the access point unit 2 in FIG. 1, the access point units 2, 2′ comprise moreover a communication module 23 for data communication with other communication units which are connected to the respective access point unit 2, 2′, namely other wireless communication terminals 1, 1′, the access control server 3 and the network server 4.

The access control server 3 comprises a value code database 32. The access control server 3 and the value code database 32 are implemented on a common computer or on separate computers. The value codes stored in the value code database 32 are preferably multi-digit alphanumerical or numerical codes. The value codes are structured, for example, in such a way that they comprise codes for identification of a geographic region, a code issuer, a network operator, a service and/or a service class. These indications can also be assigned to the individual value codes in the value code database 32, however. In an embodiment variant, assigned to the each of the value codes in the value code database are denominations corresponding to a monetary amount, a maximal access time and/or a maximal data volume. Assigned to a value code can also be specific service types or access rights.

The access control server 3 comprises a communication module 33 for data communication over the communication network 5 connected to the access control server 3. The communication network 5 is a fixed network, for example a local communication network (Local Area Network, LAN), the public switched telephone network (PSTN) or the Internet. The access control server 3 comprises furthermore an access control module 31 with a validation module 311, a clearance module 312, a cancellation module 313, a blocking module 314 and a billing module 315, which are each implemented as programmed software modules and control a processor of the access control server 3. The access control module 31 is supplied to the processor(s) of the access control server 3 by means of a computer program product comprising a computer-readable medium.

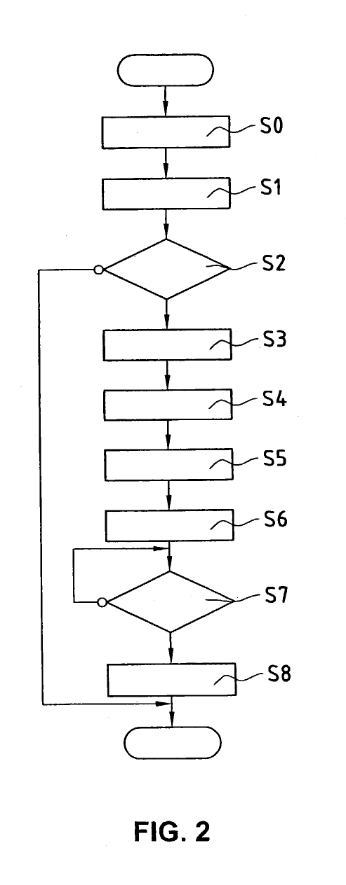

In the following paragraphs the course of the access control for the wireless local communication network is described with reference to FIG. 2.

The user of the wireless communication terminal 1 receives a value code, in exchange for payment, for instance at a sales point, printed on a value card under a removable cover layer, or at an issue terminal, displayed on a screen or printed on a piece of paper. In step S0, the prepaid value code is received by the request module 12 of the wireless communication terminal 1 of the user and is transmitted by means of the communication module 11 from the wireless communication terminal 1 via the air interface 21 to the access point unit 2. The request module 12 receives the value code from the user, for example via input means of the wireless communication terminal 1 of the user, or reads the value code from a data carrier which is connected to the wireless communication terminal 1 via an interface with contacts or a contactless interface.

In step S1, the received value code is forwarded by the communication module 23 to the access control module 31. The access control module 31 is preferably located in the access control server 3, as described above; in another embodiment it could also be implemented in the access point unit 2, however. Together with the value code, the communication module 23 transmits to the access control module 31 an operator identification for the operator of the access control unit 2. Instead of an operator identification, an identification of the access point unit 2 can also be transmitted to the access control module and the assigned operator identification of the operator responsible therefor can be determined there.

In step S2, checked by the validation module 311 is whether the received value code coincides with a valid value code stored in the value code database 32. If the received value code cannot be validated by the validation module 311, the wireless communication terminal 1 is refused access to the access-controlled communication network modules and thereby access to the wireless local communication network and/or to the communication network 5. In one embodiment, access can be cleared in a limited way without valid value code, for example access can be limited to help information as to where valid value codes are available and how to proceed in obtaining a value code with unlimited access. The validity of the value code can also be made to depend upon the received, or respectively derived, operator identification or the received identification of the access point unit 2. Thus considered invalid by the validation module 311 can be, during access via certain access point units 2, value codes for a certain geographic area, from a particular code issuer, for a certain network operator, for a particular service, for a certain service class or service type and/or with a particular denomination or access right, for example.

Through application of the access control to the communication module 23, the wireless communication terminal 1 is refused, or cleared for, access to the wireless local communication network. Through application of the access control to the switching module 43, access of the wireless communication terminal 1 is limited to the part of the wireless local communication network covered by the respective access point unit 2, or clearance is also given for access to further access point units 2′ connected to the access point unit 2. That means that access of the wireless communication terminal 1 is limited to communication units which are directly connected to the respective access point unit 2, or access is cleared to communication units which are connected to other access point units 2′. Through use of the access control to the communication module 33, the wireless communication terminal is refused, or cleared for, access to the communication network 5 which is connected to the wireless local communication network. By means of further access-controlled communication network modules (not shown), the wireless communication terminal 1 can be refused, or cleared for, access to specific communication units, such as databases, data servers, mail servers, file-transfer servers and the like.

If the received value code can be validated by the clearance module 312, access to the access-controlled communication network modules is cleared for the wireless communication terminal 1 in step S3.

In step S4, in an embodiment variant, the blocking conditions for the received value code are determined by the blocking module 314. The blocking conditions result, for example, from the service class, the denomination, the specific service type or the access rights which are contained in the value code or are assigned to the value code in the value code database 32. The blocking conditions correspond, for instance, to a maximal duration of clearance, during which access to the access-controlled communication network modules 23, 33, 41 is granted to the wireless communication terminal 1, and/or a maximal volume of data which the wireless communication terminal 1 can obtain via the wireless communication network or respectively the access-controlled communication network modules 23, 33, 41. The blocking conditions can also be defined, however, by a set clearance time, for example by a set maximal clearance duration or a set blocking time point, or by a maximal data volume, which are independent of the received value code.

In step S5, a monetary amount is credited by the billing module 315 to the operator, who is identified by the operator identification received or contained in the received value code. The monetary amount corresponds, for example, to a fixed proportion of the denomination of the value code or it is set independently of the value code. The monetary amount is credited to an account assigned to the respective operator.

In step S6, the received value code is cancelled in the value code database 32 by the cancellation module 313, either by corresponding marking, or by deletion, of the respective value code.

Checked by the blocking module 314 in step S7 is whether the blocking conditions have been fulfilled, and, if applicable, access to the access-controlled communication network modules 23, 33 41 is blocked in step S8 for the wireless communication terminal 1.

### INDUSTRIAL APPLICABILITY

The present invention makes possible in particular access to wireless local communication networks, so-called WLAN, and access via such WLAN to further communication units, such as, for instance, the Internet.

1. A wireless local communication network, comprising:
at least one wireless communication terminal,
at least one access point unit with a transceiver for communication with the wireless communication terminal via an air interface,
an access control server, connected to the access point unit, with an access control module for checking the access authorization of the wireless communication terminal,
an access control module for checking the access authorization of the wireless communication terminal,
a request module, in the wireless communication terminal, for transmission of a prepaid value code via the air interface to the access point unit,
a value code database,
a validation module, in the access control module, for validation of the received value code in the value code database,
a clearance module, in the access control module, for clearance of access to access-controlled communication network modules for the wireless communication terminal, and
a cancellation module, in the access control module, for cancellation of the received validated value code in the value code database,
whereby the access point unit comprises a communication module for transmission to the access control server of the prepaid value code and of an operator identification.

2. The wireless local communication network according to claim 1, wherein the access control server comprises a billing module for crediting a monetary amount to the operator of the access point unit identified through the operator identification.

3. The wireless local communication network according to claim 1, wherein the access control module comprises a blocking module for determining blocking conditions based on the received value code and for blocking access for the wireless communication terminal to the access-controlled communication network modules upon fulfillment of the determined blocking conditions.

4. The wireless local communication network according to claim 1, wherein the access control module comprises a blocking module for blocking access for the wireless communication terminal to the access-controlled communication network modules according to a predetermined clearance time or according to a predetermined data volume.

5. The wireless local communication network according to claim 1, wherein the access-controlled communication modules comprise a communication module for data communication with other communication units over the wireless local communication network.

6. An access control method for a wireless local communication network, comprising:
transmission of a prepaid value code by a wireless communication terminal via an air interface of the wireless local communication network to an access point unit of the wireless local communication network,
validation of the received value code for checking the access authorization of the wireless communication terminal in a value code data base,
clearance for access to access-controlled communication network modules for the wireless communication terminal and cancellation of the received validated value code in the value code database, and
transmission of the prepaid value code and of an operator identification from the access point unit to an access control server.

7. The access control method according to claim 6, comprising crediting of a monetary amount by the access control server to the operator of the access point unit identified through the operator identification.

8. The access control method according to claim 6, comprising determination of blocking conditions based on the received value code and blocking of access for the wireless communication terminal to the access-controlled communication network modules upon fulfillment of the determined blocking conditions.

9. An access control server, which is connectible to a wireless local communication network, which comprises a value code database and which comprises an access control module for checking the access authorization of a wireless communication terminal to the wireless local communication network, the access control module comprising a validation module for validating in a value code database a prepaid value code received from the wireless communication terminal via an air interface of the wireless local communication network, the access control module comprising a clearance module for clearing access to the wireless local communication network for the wireless communication terminal, and the access control module comprising a cancellation module for cancelling the received validated value code in the value code database, and
wherein the access control server comprises a billing module for crediting a monetary amount to an operator of an access point unit of the wireless local communication network identified through the operator identification received from the access point unit which has transmitted the prepaid value code to the access control server.

10. The access control server according to claim 9, wherein the access control module comprises a blocking module for determining blocking conditions based on the received value code and for blocking access to the wireless local communication network for the wireless communication terminal upon fulfillment of the determined blocking conditions.

11. A computer program product comprising: a computer-readable medium with computer program code means, contained therein, for control of a processor of an access control server connectible to a wireless local communication network in such a way that the access control server validates in a value code database a prepaid value code received from a wireless communication terminal over an air interface of the wireless local communication network, wherein the access control server clears access to the wireless local communication network for the wireless communication terminal and wherein the access control server cancels in the value code database the received validated value code, and
wherein the computer program product comprises further computer program code means which control the processor of the access control server in such a way that the access control server credits a monetary amount to an operator of an access point unit of the wireless local communication network, which operator is identified through an operator identification which has been received from the access point unit which has transmitted the prepaid value code to the access control server.

12. The computer program product according to claim 11, comprising further computer program code means which control the processor of the access control server in such a way that the access control server determines blocking conditions based on the received value code and blocks access to the wireless local communication network for the wireless communication terminal upon fulfillment of the determined blocking conditions.
